(19) United States
(12) Patent Application Publication
(10) Pub. No.: US 2016/0051092 A1
(43) Pub. Date: Feb. 25, 2016

(54) FRYING DEVICE

(71) Applicant: Corporation Daeji C&C, Paju (KR)

(72) Inventor: Eun Mi BANG, Goyang (KR)

(21) Appl. No.: 14/779,955

(22) PCT Filed: Mar. 24, 2014
(86) PCT No.: PCT/KR2014/002426

§ 371 Date: Sep. 24, 2015

(30) Foreign Application Priority Data
Mar. 25, 2013 (KR) 10-2013-0031261

(51) Int. Cl. A47J 37/12

(52) U.S. Cl. CPC A47J 37/1223

(57) ABSTRACT

The present invention relates to a frying device which can prevent the sediments of cooked food from sticking to the upper side of an inclined lower plate that forms an oil cask through the circulation of oil filled inside the oil cask, the frying device comprising: a case; an oil cask; two ultrasonic vibration units provided in the front part and the rear part of the oil cask; two heater units provided on both sides of the oil cask; a sediment collection cask fixed so as to communicate with the oil cask; a filtering circulation unit provided between the sediment collection cask and the oil cask; and a control unit for controlling the ultrasonic vibration units, the heater units, and the filtering circulation unit, and having an operating portion connected thereto.

### TECHNICAL FIELD

The present invention relates to a frying device, and in particular to a frying device which makes it possible to prevent food sediments from sticking to an upper surface of an inclined, lower plate which belongs to an oil cask, in such a way to circulate oil filled in the inside of the oil cask.

### BACKGROUND ART

In general, a frying device which uses electricity is used so as to fry meat, for example, a chicken meat, fish, vegetable, etc. in oil, which was previously coated with wheat flour or to fry various breads, for example, donut, croquette, etc. mixed with various sub-materials.

In addition, such a frying device which uses electricity is widely used in various places, for example, a fast food restaurant, a bakery, etc. since a need for fried foods increase thanks to a food and live style change in recent years and an increase in a western style food.

As an example of a conventional frying device which uses electricity, there is a Korean patent registration number 1196864 entitled “a cooking device for frying food” (hereinafter referred to “a conventional cooking device for frying food”).

The above conventional cooking device for frying food includes a case providing an inner space; a heating plate arranged inside the case and configured to supply heat; and an oil cask disposed at the case for storing oil for frying, wherein the oil cask includes an oil circulation part formed as an edge of a lower surface thereof protrudes downward, thus providing an oil flow passage therein. The oil cask includes a horizontal surface part wherein a lower surface of an inner portion of the oil circulation part is formed horizontal. The oil flow passage is disposed lower than the height of the bottom surface of the oil cask, and the oil cask and the heating plate are disposed spaced apart from each other at a predetermined distance, thus providing a direct heating way. Inside the oil cask, a heat diffusion plate is arranged horizontal. The heat diffusion plate includes a plurality of holes which are formed at regular intervals.

The conventional cooking device for frying food has advantages in the way that since the lower surface of a frying container is formed horizontal, heat can uniformly transfer to the oil filled in the inside of the oil cask.

However, when the conventional cooking device for frying food is used, sediments which produce when frying foods in oil may remain on the bottom surface of the oil cask, whereupon impurities may stick to the bottom surface of the oil cask, thus causing a unsanitary problem.

In addition, since the impurities stuck to the bottom surface of the oil cask may be heated by heat, and the bottom surface of the oil cask may be oxidized and may turn black, which also causes an unsanitary problem, and service life of the oil cask may decrease.

### DISCLOSURE OF INVENTION

Accordingly, the present invention is made to resolve the above-mentioned problems.

It is an object of the present invention to provide a frying device wherein it is possible to prevent food sediments from sticking to an upper surface of an inclined, lower plate which belongs to an oil cask in such a way to circulate oil filled in the inside of the oil cask, and a heating temperature of a heater part can be decreased by vibrating oil using an ultrasonic wave vibration part in the inside of the oil cask when frying foods, whereupon it is possible to remove sediments while circulating oil.

It is another object of the present invention to provide a frying device wherein small size sediments included in oil can be removed during a circulation of oil filled in the oil cask.

It is further another object of the present invention to provide a frying device wherein heat can radiate from a heater part installed at both sides of an inner, lower side of the oil cask toward an inner circumferential surface of the oil cask, and an ultrasonic wave vibration part is provided in the center of both heater parts, whereupon heated air can ascend with the aid of natural convection at both sides of the oil cask and can gather in the center, and vibrations can transfer through oil in the center, thus quickly and uniformly cooking foods.

It is still further another object of the present invention to provide a frying device wherein oil filled in the inside of an oil cask can be repeatedly circulated while generating vortex in a clockwise direction or a counterclockwise direction during a frying procedure of foods, whereupon oil can uniformly penetrate into food, thus uniformly cooking foods.

It is still further another object of the present invention to provide a frying device wherein foods can rotate while moving a little during a frying procedure of foods in such a way to move a cooking container filled with foods, thus uniformly cooking foods and preventing foods from being fried stuck to each other.

To achieve the above objects, there is provided a frying device, which may include, but is no limited to, a case which is hollow and includes a circular hole at its upper plate; an oil cask which is arranged passing through the circular hole and includes a circumference fixing shoulder formed at a circumference of its top and fixed at a circumference of the circular hole, a cylindrical pipe the top and bottom of which are open, and an inverted cone shaped inclined, lower plate formed at the open portion of the lower side of the cylindrical pipe, thus forming a discharge hole at a lower portion of the front side; a pair of ultrasonic wave vibration parts which are provided at a front side and a rear side of an inner lower portion of the oil cask; a pair of heater parts which are dispose at both sides of an inner lower portion of the oil cask and are configured to radiate heated air; a sediment collection container which is fixed at a lower portion of the discharge hole while communicating with the oil cask; a filtering circulation part which is disposed between the sediment collection container and the oil cask so as to filter the oil discharging from the sediment collection container and circulate back into the oil cask; and a control part which controls the ultrasonic wave vibration part, the heater parts and the filtering circulation part, wherein an operation part is connected to the control part.

According to the frying device of the present invention, the filtering circulation part may include, but is not limited to, a first pipe which extends from a lower portion of the sediment collection container and includes a control opening and closing valve at its intermediate portion, which is connected to the control part; a filter part which is connected to an end portion of the first pipe and allows to filter sediments; and a second pipe which extends from the filter part and is connected to the top of the cylindrical part of the oil cask and includes a pump at its intermediate portion, which is connected to the control part, and feeds the oil filtered by the filter part back into the oil cask.

In addition, according to the frying device of the present invention, the filtering circulation part comprises a fine filtering filter part at the second pipe which connects the pump and the oil cask.

In addition, according to the frying device of the present invention, each of the heater parts may include, but is not limited to, a body which includes a heat discharge hole at its outer side so as to discharge heat in the direction opposite to the direction where the two heater parts face each other; and a heater which is disposed in the inside of the body and allows to discharge heat based on the supply of electricity.

In addition, according to the frying device of the present invention, there is further provided an oil suction input part which is provided at a circumference of the cylindrical pipe so as to continuously circulate the oil filled in the oil cask with a vortex in a clockwise direction and a counterclockwise direction, and the control part controls the oil suction input part.

In addition, according to the frying device of the present invention, the oil suction input part may include, but is not limited to, a first eruption pipe which is disposed horizontal passing through a circumference of the cylindrical pipe and allows to erupt the oil in a clockwise direction on an inner circumferential surface of the cylindrical pipe; a second eruption pipe which is disposed horizontal passing through a circumference of the cylindrical pipe and allows to erupt the oil in a counterclockwise direction on an inner circumferential surface of the cylindrical pipe; and a normal and reverse direction pump which is installed on an outer circumferential surface of the cylindrical pipe and is connected to the control part, wherein the first eruption pipe and the second eruption pipe are connected through a connection pipe, thus sucking, circulating and inputting the oil filled in the inside of the oil cask.

In addition, according to the frying device of the present invention, there is further provided a food frying container which is installed over a circumference of the top of the oil cask and is submerged in the inside of the oil cask and is filled with foods and is configured to rotate and move while the oil is being inputted from the oil suction input part into the inside of the oil cask.

In addition, according to the frying device of the present invention, the food frying container may include, but is not limited to, a circumference engaging ring which is disposed protruding outward from a circumference of its top, wherein a lower end portion thereof is formed in a shape of a semispherical surface at front and rear sides of a lower portion thereof, and which includes two vertical rods or rollers contacting close with an upper surface of the circumference fixing shoulder; an inverted cone shaped or cylindrical food accommodation container which is formed protruding downward from the inside of the circumference engaging ring, wherein the top of which is open, and the bottom is closed, and the food accommodation container is formed of a mesh or a punched plate; and a plurality of collision wings which are formed protruding outward from an outer circumferential surface of the food accommodation container and are configured to collide with the oil during the input of oil from the oil suction input part to the inside of the oil cask, thus rotating and moving the food accommodation container.

In addition, according to the frying device of the present invention, the collision wings are formed in such a way that the inclined directions are alternately opposite to each other in a circumference direction.

In addition, according to the frying device of the present invention, the circumference fixing shoulder comprises a V-shaped guide groove which is formed in an arc shape on a circumference of its top, wherein a semispherical surface formed at a lower end portion of each of the vertical roads is inserted into the V-shaped guide groove.

In addition, according to the frying device of the present invention, the oil cask comprises an engaging shoulder formed at a circumference of an intermediate portion in the inside of the cylindrical pipe, and the frying device comprises a grill plate G the circumference of which is mounted on the top of the engaging shoulder, so the grill plate G is engaged horizontal at an intermediate portion of the oil cask.

### Advantageous Effects

In the present invention, since it is possible to prevent food sediments from sticking to an upper surface of an inclined, lower plate which belongs to an oil cask during a circulation of oil filled in the inside of the oil cask, foods can be sanitarily fried, and it does not need to clean the inside of the oil cask so as to remove any food sediments, and since any oxidation on a bottom surface of the oil cask can be prevented, service life of the oil cask may be long, and since oil in the inside of the oil cask can vibrate using an ultrasonic wave vibration part, foods can be fried while lowering heating temperature of a heater part, energy consumption may be minimized. To this end, the present invention can provide an energy saving type frying device. Since food sediments can be removed while circulating oil, more sanitary frying may be obtained.

The present invention may provide more sanitary frying in such a way to remove small size sediments contained in oil during a circulation of oil filled in the oil cask.

In the present invention, since heat can be radiated from a heater part provided at both lower sides of the inside of the oil cask to an inner, circumferential surface of the oil cask, and an ultrasonic wave vibration part is provided in the center of both the heater parts, heat may ascends at both sides of the oil cask with the aid of natural convection and may gather in the center, and since vibrations occur in oil, it is possible to more quickly and uniformly cook foods, whereupon good quality fried food can be made.

In the present invention, since vortex may be made in a clockwise direction or a counterclockwise direction in the oil filled in the oil cask, and the coil repeatedly circulates, the oil can be efficiently inputted into the food, thus uniformly heating the food, and the food can be more quickly fried.

In the present invention, since a cooking container in which foods are filled, moves, foods can rotate and can be uniformly cooked when frying the foods. Since it moves finely, the foods can be prevented from sticking to each other, which results in good fried foods.

### BRIEF DESCRIPTION OF DRAWINGS

FIG. 1 is a perspective view illustrating a frying device according to the present invention.

FIG. 2 is a perspective view illustrating key parts of a frying device according to the present invention.

FIG. 3 is a cross sectional view taken along line A-A in FIG. 1.

FIG. 4 is a cross sectional view taken along line B-B in FIG. 3.

FIG. 5 is a schematic cross sectional view taken along line C-C in FIG. 4.

FIG. 6 is a cross sectional view taken along line D-D in FIG. 3.

FIG. 7A is an enlarged perspective view illustrating a food frying container according to the present invention.

FIG. 7B is a perspective view illustrating another type of a food frying container in FIG. 7A.

FIG. 8 is a schematic plane cross sectional view illustrating an operation state of an oil suction input part according to the present invention.

FIG. 9 is a view illustrating a movement state of a food frying container according to the present invention.

FIG. 9A is a schematic plane cross sectional view of the present invention.

FIG. 9B is a cross sectional view taken along line E-E in FIG. 9A.

FIG. 9C is a cross sectional view taken along line F-F in FIG. 9B.

### MODES FOR CARRYING OUT THE INVENTION

The exemplary embodiments of the present invention will be described with reference to the accompanying drawings. The present invention may be implemented in different types, and the exemplary embodiments are not limited to the disclosure.

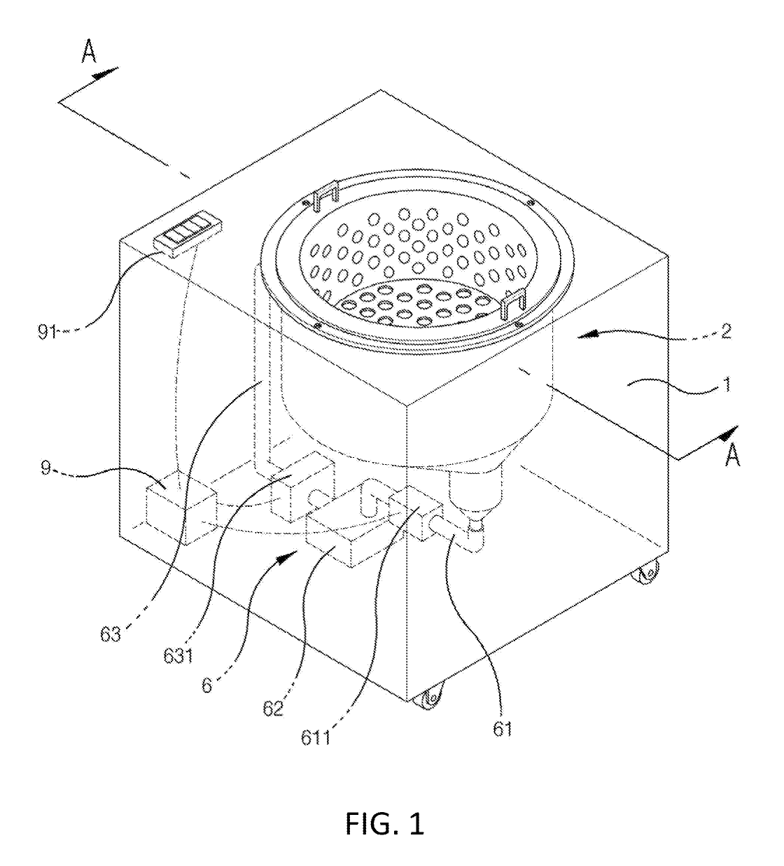

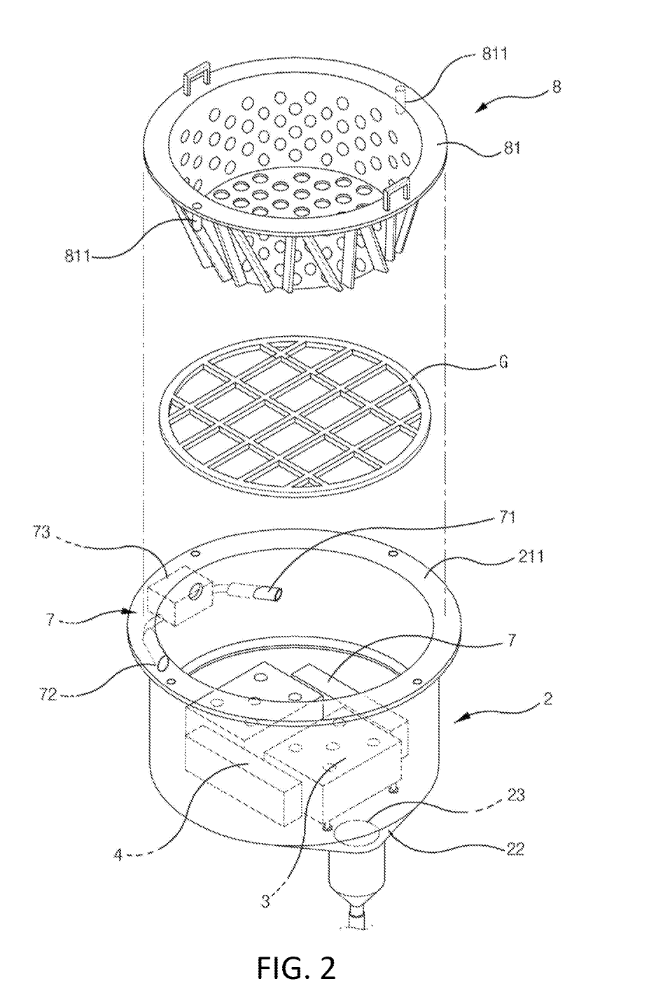

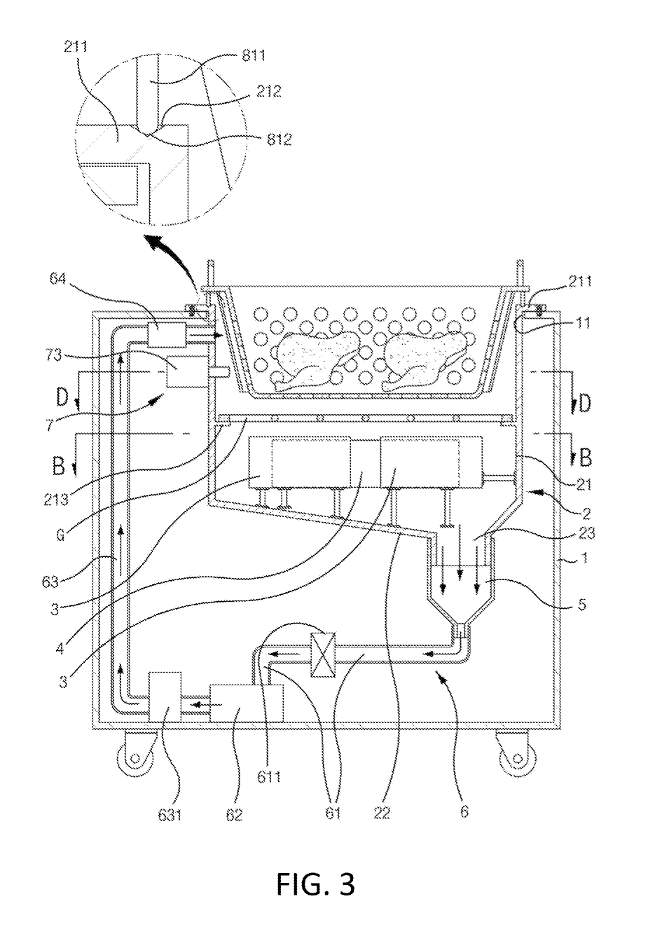

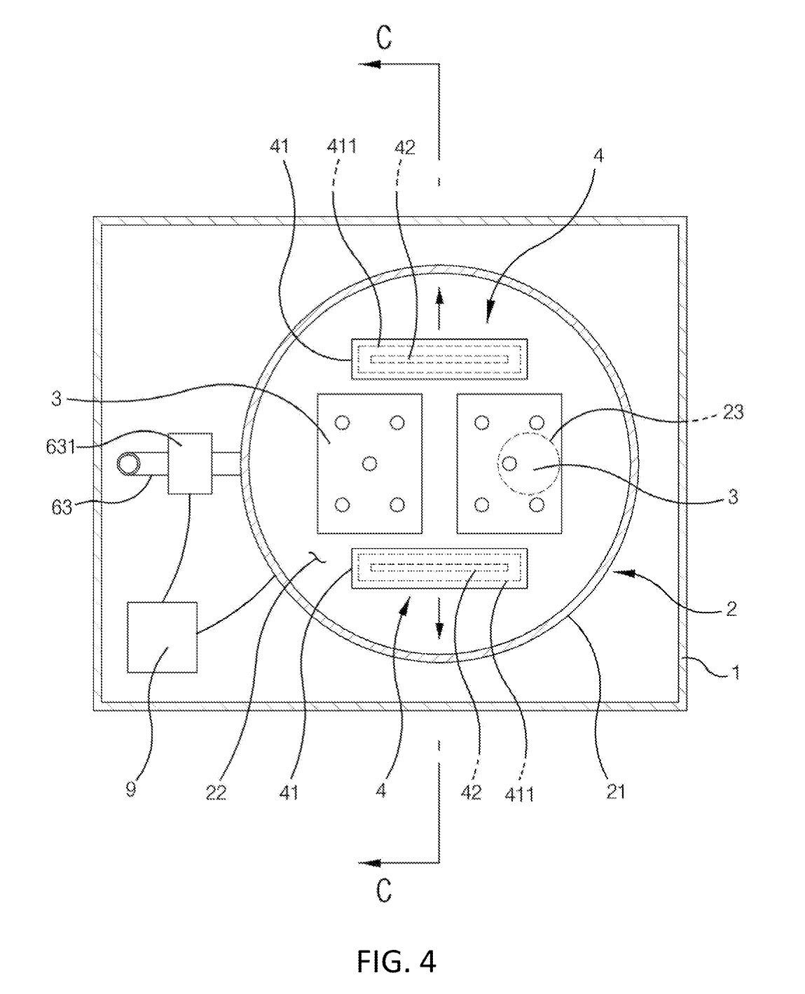

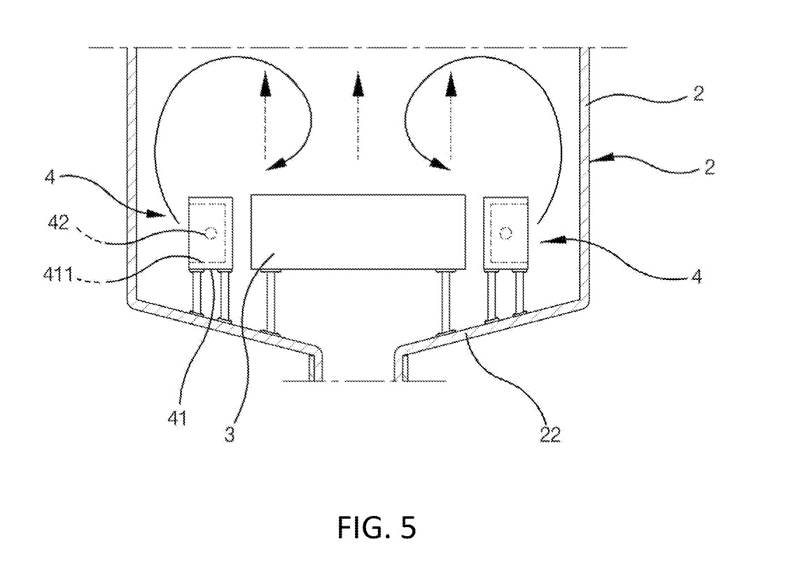

FIG. 1 is a perspective view illustrating a frying device according to the present invention. FIG. 2 is a perspective view illustrating key parts of a frying device according to the present invention. FIG. 3 is a cross sectional view taken along line A-A in FIG. 1. FIG. 4 is a cross sectional view taken along line B-B in FIG. 3. FIG. 5 is a schematic cross sectional view taken along line C-C in FIG. 4.

As illustrated therein, the frying device according to the present invention may include, but is not limited to, a case 1 which is hollow and has a circular hole 11 on its upper plate; an oil cask 2 which is arranged passing through the circular hole 11 and is provided in the inside of the case 1; an ultrasonic wave vibration part 3 disposed in the inside of the oil cask 2; a heater part 4 provided in the inside of the oil cask 2; a sediment collection container 5 installed at a discharge portion of the oil cask 2; a filtering circulation part 6 disposed between the sediment collection container 5 and the oil cask 2; and a control part 9 which controls the ultrasonic wave vibration part 3, the heater part 4 and the filtering circulation part 6, wherein an operation part 91 is connected to the control part 9.

The frying device according to the present invention may further include a food frying container 8 which is fixed over the surrounding of the top of the oil container 2 and is submerged in oil. The food frying container 8 is filled with foods and is formed of a mesh or a punched plate in a conical shape or a cylindrical shape.

In addition, as illustrated in FIGS. 1 to 3, the case 1 is made of a metallic material and may be formed in a rectangular parallelepiped shape. In the attached drawings, a rectangular parallelepiped shape is illustrated. The case 1 is configured to cover the oil cask 2 and the filtering circulation part 6.

The control part 9 is provided in the inside of the case 1. An operation part 91 is provided on top of the case 1 for a user to operate the device with. Movement wheels may be provided on the lower plate of the case 1.

As illustrated in FIGS. 1 to 3, the oil cask 2 according to the present invention is arranged passing through the circular hole 11 and is provided in the inside of the case 1, and cooking oil (edible oil, etc.) is filled in the inside thereof. It is preferred that the oil cask 2 is made of a metallic material, for example, a stainless, etc. so that the oil cask 2 cannot be deformed by the hot oil.

The oil cask 2 includes a surrounding fixing shoulder 211 which is formed at a surrounding of the top thereof and is fixed at a surrounding of the circular hole 11, and a cylindrical pipe 21 the top and bottom of which are open. In addition, an inclined, lower plate 22 shaped in an inverted cone shape is provided at a lower open portion of the cylindrical pipe 21 so that a discharge hole 23 can be formed eccentric toward a lower side of the front part. It is preferred that a lower circumference of the cylindrical pipe 21 and an upper circumference of the inclined, lower plate 22 are welded.

The inclined, lower plate 22 is installed oblique in an inverted cone shape and eccentric toward the discharge hole 23 and allows to smoothly discharge oil to the discharge hole 23. The inclined, lower plate 22 can prevent food sediments from sticking to an upper surface with the aid of operation of the filtering circulation part 6. This operation will be described later.

As illustrate in FIGS. 2 to 5, the ultrasonic wave vibration part 3 is provided two in number at a front side and a rear side, respectively, of the inner, lower side of the oil cask 2 so as to vibrate oil filled in the oil cask 2 with the aid of operation of the control part 9. The ultrasonic wave vibration part 3 allows to vibrate oil when electricity is supplied. Since such an ultrasonic wave vibration part 3 is known, the configuration and operation thereof will not be described.

Since the oil can vibrate using the ultrasonic wave vibration part 3, even though heating temperature of the heater part 4 is lowered, oil can penetrate deep into the inside of food with the aid of vibrations. Therefore, the frying device according to the present invention is advantageous to uniform cook foods even though the temperature of oil is lowered to about 100° C. to 120° C. Since any oxidation of oil can be prevented, oil can be used fresh for a long time.

Referring to FIGS. 2 to 5, the heater part 4 of the present invention is provided two in number symmetrically at both sides of an inner, lower portion of the oil cask. Each heater part 4 can radiate heat, thus heating oil filled in the oil cask 2.

The heater part 4 may include, but is not limited to, a body 41 having a heat discharge hole 411 at an outer side thereof so that two heater parts 4 can radiate in the directions opposite to the direction where the two heater parts 4 face, and a heater 42 which is provided inside the body 41 so as to radiate heat based on the supply of electricity.

Since oil vibrates in the inside of the oil cask 2 by the ultrasonic wave vibration part 3, the foods can be fried even when the heating temperature of the heater part 4 is lowered. The present invention is advantageous to provide an energy saving type frying device which is able to minimize the use of energy.

In addition, heat can radiate from the heater part 4 disposed at both sides of an inner, lower portion of the oil cask 2 to an inner circumferential surface of the oil cask 2, and the ultrasonic wave vibration part 3 is provided in the center of the two heater parts 4, so the heat can ascend with the aid of natural convection at both sides of the oil cask 2 and can gather in the center, and oil can vibrate in the center, thus quickly and uniformly cooking foods. Since foods can be more quickly and uniformly cooked, good quality fried food can be cooked.

In addition, as illustrated in FIG. 3, the sediment collection container 5 according to the present invention is fixed at a lower side of the discharge hole 23 while communicating with the oil cask 2 and is configured to temporarily collect food sediments which may produce during frying before the filtering circulation part 6 is operated.

The filtering circulation part 6 is formed in a cylindrical shape the top and bottom of which are open. It is preferred that the lower side thereof is configured in an inverted cone shape wherein the top is wide and the bottom is narrow in order for the sediments to be easily discharged.

Referring to FIGS. 1 to 3, the filtering circulation part 6 is disposed between the sediment collection container 5 and the oil cask 2 to filter the oil discharging from the sediment collection container 5 and circulate into the oil cask 2, thus preventing oil from sticking to an upper surface of the inclined, lower plate 22 of the oil cask 2.

The above filtering circulation part 6 may include, but is not limited to, a first pipe 61 which extends from a lower side of the collection container and includes a control opening and closing valve 611 disposed at its intermediate portion; a filter part 62 connected to an end of the first pipe 61 so as to filter sediment; and a second pipe 63 which is connected to the top of the cylindrical pipe 11 of the oil cask 2 and includes a pump 631 at its intermediate portion and is configured to let the oil filtered by the filter part 62 flow back into the oil cask 2.

The control opening and closing valve 611 is connected to the control part 9 and is configured to open and close the first pipe 61 in accordance with a control signal of the control part 9. The pump 631 is connected to the control part 9 and forcibly circulates the oil through the first pipe 61 and the second pipe in accordance with a control signal of the control part 9. Since the control opening and closing valve 611 and the pump 631 are known, the detailed configuration and operation will be now described.

Therefore, when a user, if necessary, operates the operation part 91 so as to selectively operate the pump 631 of the filtering circulation part 6, an operation cycle is formed, wherein the oil filled in the inside of the oil cask 2 discharges and flows back inside the oil cask 2. When the filtering circulation part 6 operates, the oil filled in the inside of the oil cask 2 flows downward, and the sediment collected on the upper surface of the inclined, lower plate 22 of the oil cask 2 discharges downward on the inclined, lower plate 22, whereupon it is possible to prevent the sediments of foods from sticking to an upper surface of the inclined, lower plate 22.

Since the sediments can be prevented from sticking to an upper surface of the inclined, lower plate 22, it is possible to sanitarily fry foods, and it does not need to clean the inside of the oil cask 2 so as to remove sediments. Since sediments are prevented from remaining on and sticking to the inclined, lower plate 22 of the oil cask 2, it is possible to prevent any oxidation on a lower surface of the oil cask 2, namely, an upper surface of the inclined, lower plate 22 which occurs due to the heating of sediments stuck to the lower plate of the conventional oil cask 2. Therefore, service life of the oil cask 2 can be long, and sanitary frying will be possible.

Meanwhile, a fine filtering filter part 64 may be provided at the second pipe 63 interconnecting the pump 631 form the filtering circulation part 6 and the oil cask 2. The fine filtering filter part 64 is able to filter fine sediments thanks to the more intense meshes of the filtering mesh than the filter part 62. The above fine filtering filter part 64 is known.

Therefore, since the fine sediments contained in the oil can be removed during the circulation of the oil filled in the oil cask 2, more sanitary frying cooking is possible.

The operations of the frying device according to the present invention will be described below.

Referring to FIGS. 1 to 5, when the frying is performed using the frying device according to the present invention, oil is filled into the inside of the oil cask 2, and the user operates the operation part 91. An operation signal is inputted into the control part 9 so as to operate two heater parts 4 and two ultrasonic wave vibration pats 3.

The oil filled in the oil cask 2 is heated by the operation of the heater parts 4, and the oil vibrates by the operations of the ultrasonic wave vibration parts 3.

Next, the food frying container 8 with the foods being filled in the inside of the oil cask 2 is submerged in the oil. After a predetermined time passes by, the food frying container 8 is removed from the oil cask 2, thus finishing the frying of foods.

During the cooking of the foods performed in the above method, the heater parts 4 provided at both sides of an inner, lower portion of the oil cask 2 radiate heat toward the inner circumferential surface of the oil cask 2. Since the ultrasonic wave vibration parts 3 are provided in the center of the heater parts 4, the heated air ascends at both sides of the oil cask 2 thanks to natural convection and gathers in the center, and vibrations occur in the oil, whereupon the foods can be more quickly and uniformly cooked.

After the frying of the foods is finished in such a method, the user stops the operations of the heater parts 4 and the ultrasonic wave vibration parts 3 by handling the operation part 91.

When the user, if necessary, inputs an operation signal of the filtering circulation part 6 into the control part 9 by operating the operation part 91, the control part 9 operates the control opening and closing valve 611 forming the filtering circulation part 6, and the pump 631, and the sediments in the sediment collection container 5 and the oil in the oil cask 2 are filtered, and only the filtered clean oil is inputted again into the oil cask 2. So, the oil in the inside of the oil cask 2 is circulated and fed back.

When the circulation of the oil is finished in the above method, the control opening and closing valve 611 is closed again by the operation of the operation part 91, and the pump 631 is stopped.

When the filtering circulation part 6 is operated, the oil in the inside of the oil cask 2 moves downward, and the sediments gathered on the upper surface of the inclined, lower plate 22 of the oil cask 2 discharges downward on the upper surface of the inclined, lower plate 22. Therefore, it is possible to prevent food sediments from sticking to the upper surface of the inclined, lower plate 22.

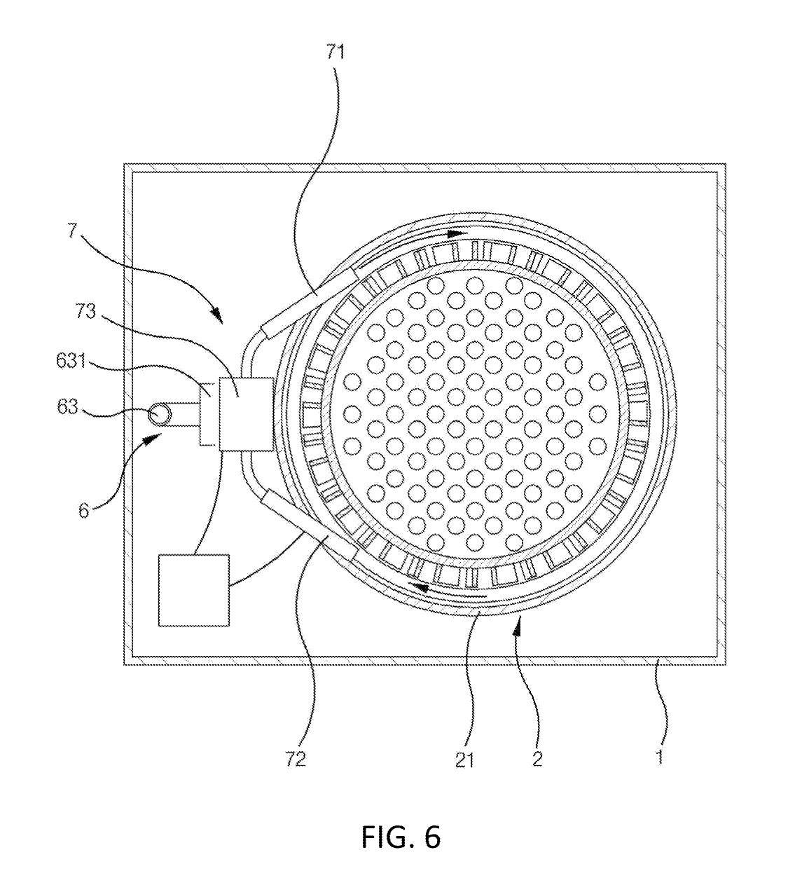

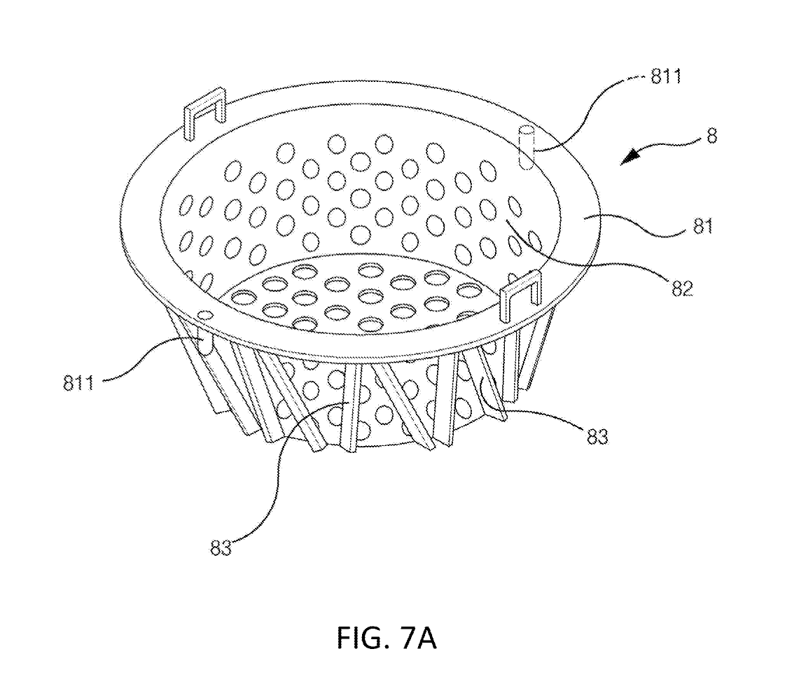

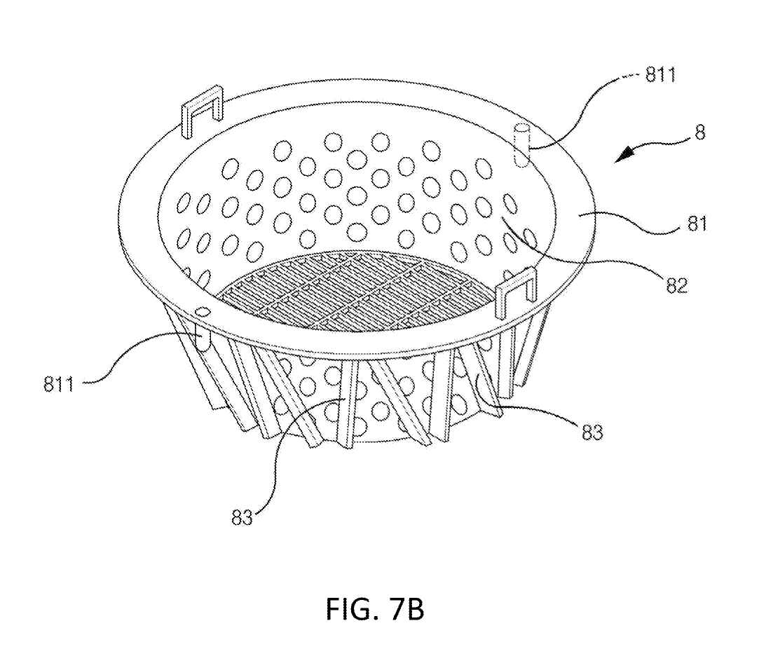

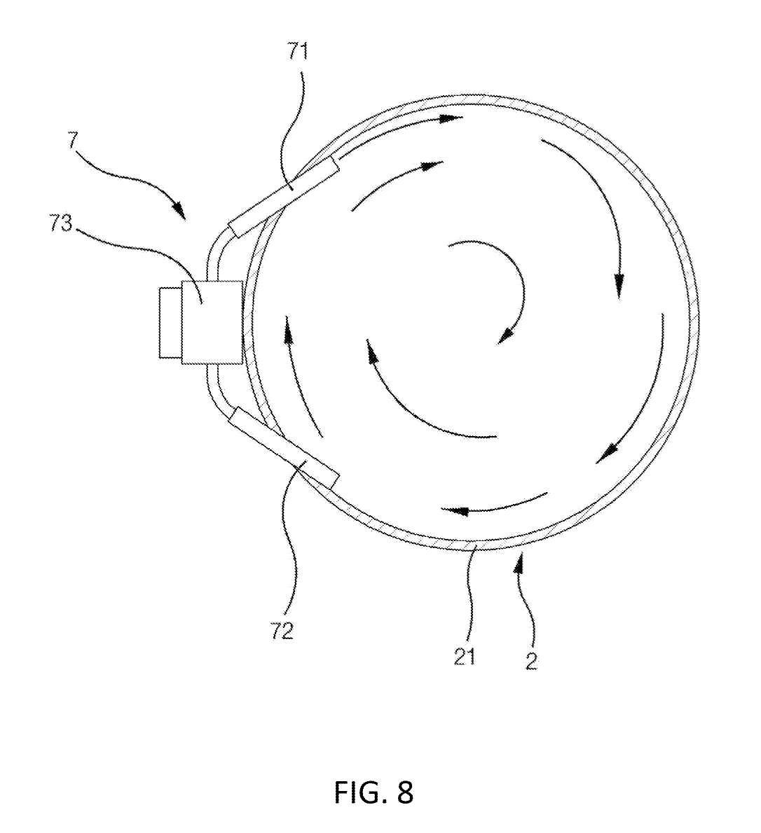

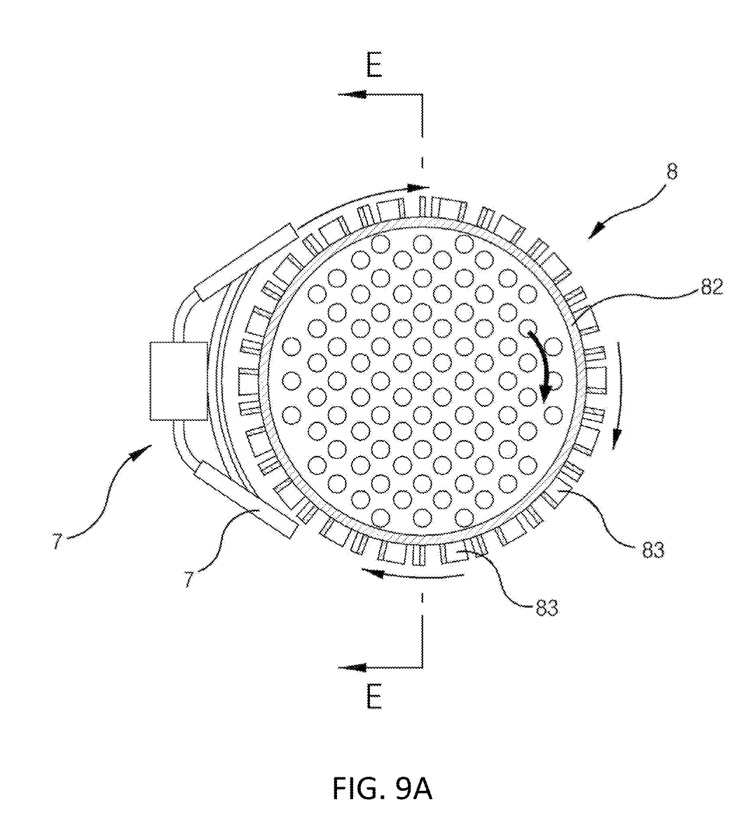

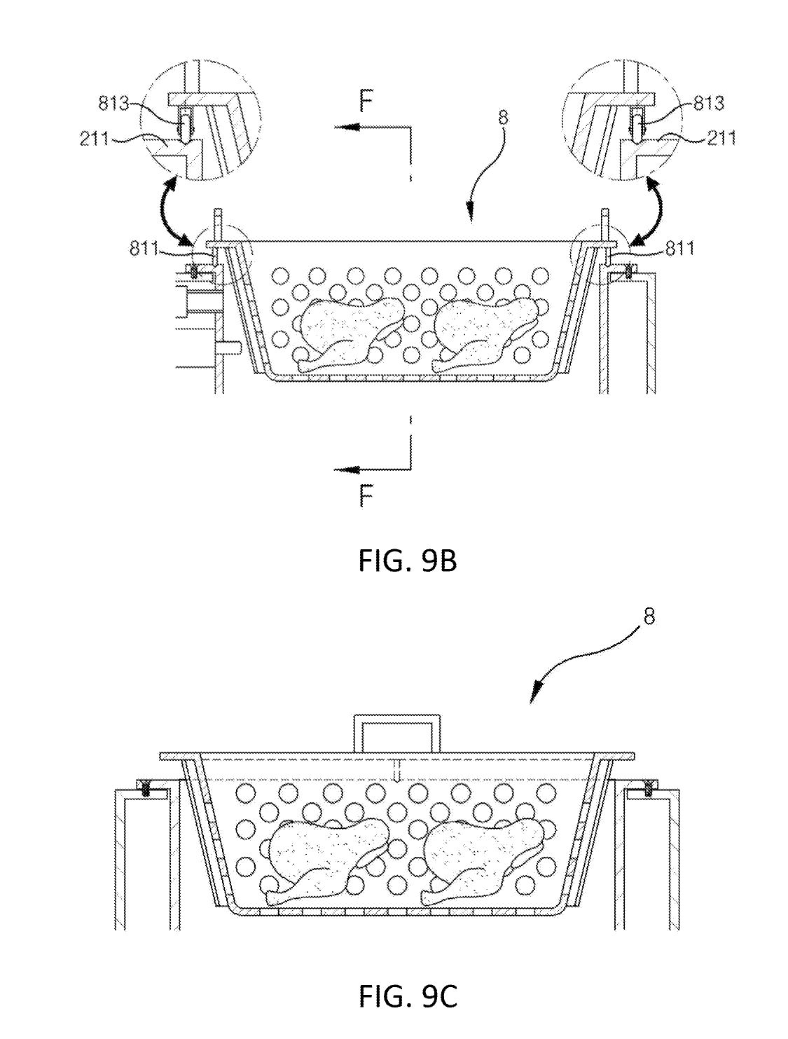

FIG. 6 is a cross sectional view taken along line D-D in FIG. 3. FIG. 7A is an enlarged perspective view illustrating a food frying container according to the present invention. FIG. 7B is a perspective view illustrating another type of a food frying container in FIG. 7A. FIG. 8 is a schematic plane cross sectional view illustrating an operation state of an oil suction input part according to the present invention. FIG. 9 is a view illustrating a movement state of a food frying container according to the present invention. FIG. 9A is a schematic plane cross sectional view of the present invention. FIG. 9B is a cross sectional view taken along line E-E in FIG. 9A. FIG. 9C is a cross sectional view taken along line F-F in FIG. 9B.

Referring to FIGS. 6, 8 and 9, the frying device according to the present invention may further include an oil suction input part 7 formed at a circumference of the cylindrical pipe 21 and vortexes the oil filled in the oil cask 2. The control part 9 may control the oil suction input part 7.

The oil suction input part 7 is provided at a circumference of the cylindrical pipe 21 and repeatedly vertexes the oil in the oil cask 2 in a clockwise direction or a counterclockwise direction while allowing the oil to penetrate well into the foods and transferring the sediments, which may stick to an inner circumferential surface of the cylindrical pipe 21 toward the bottom using the vortex.

The above oil suction input part 7 may includes, but is not limited to, a first eruption pipe 71 which is disposed horizontal passing through the circumference of the cylindrical pipe 21 in a tangential direction and allows to erupt the oil in a clockwise direction on an inner circumferential surface of the cylindrical pipe 21; and a second eruption pipe 72 which is disposed horizontal passing through the circumference of the cylindrical pipe 21 in a tangential direction and allows to erupt the oil in a counterclockwise direction on an inner circumferential surface of the cylindrical pipe 21. The first eruption pipe 71 and the second eruption pipe 72 are formed oblique in a horizontal state on an inner circumferential surface with respect to the cylindrical pipe so as to erupt the oil on an inner circumferential surface of the cylindrical pipe 21.

In addition, the oil suction input unit 7 may further include a normal and reverse direction pump 73 which is installed on an outer circumferential surface of the cylindrical pipe 21 and is connected to the control part 9, wherein the first eruption pipe 71 and the second eruption pipe 72 are connected thereto through a connection pipe, and the normal and reverse direction pump 73 allows to suck the oil filled in the inside of the oil cask 2 and circulate and input again the oil. The normal and reverse direction pump 73 is configured to rotate in the oil cask 2 in a normal direction (clockwise direction) or a reverse direction (counterclockwise direction) during the frying of foods, thus allowing the oil to uniformly penetrate into the foods.

Therefore, when the normal and reverse direction pump 73 rotates in a normal direction or a reverse direction in accordance with a control signal from the control part 9, the oil of the oil ask 2 is inputted through the second eruption pipe 72, and the oil inputted from the second eruption pipe 72 erupts again into the inside of the oil cask 2 in the first eruption pipe 71, so the oil circulates forming a vortex in a clockwise direction. On the contrary, when the normal and reverse direction pump 73 rotates in a reverse direction in accordance with a control signal of the control part 9, the oil of the oil cask 2 is inputted through the first eruption pipe 71, and the oil inputted from the first eruption pipe 71 erupts again into the inside of the oil cask 2 in the second eruption pipe 72, so the oil circulates forming a vortex in a counterclockwise direction. The control part 9 controls the normal and reverse direction pump 73 to rotate alternately in a normal direction or a reverse direction in accordance with an operation signal of the operation part 91 or a previously set signal.

Therefore, since the oil in the oil cask 2 continuously circulates forming a vortex in a clockwise direction or a counterclockwise direction, namely, since the oil is circulated alternately in a clockwise direction or counterclockwise direction, the oil can efficiently penetrate into the foods, thus quickly frying the foods while uniformly cooking the foods.

Referring to FIGS. 3, 6, 7A, 7B and 9, the food frying container 8 according to the present invention is submerged in the inside of the oil cask 2 and may be configured to rotate and move during the input of the oil from the oil suction input part 7 into the inside of the oil cask 2.

The food frying container 8 of the present invention may include, but is not limited to, a circumference engaging ring 81 which is disposed protruding outward from a circumference of its top, wherein a lower end portion thereof is formed in a shape of a semispherical surface 812 at front and rear sides of a lower portion thereof, and which includes two vertical rods 811 contacting close with an upper surface of the circumference fixing shoulder 211; and an inverted cone shaped or cylindrical food accommodation container 82 which is formed protruding downward from the inside of the circumference engaging ring 81, wherein the top of which is open, and the bottom is closed, and the food accommodation container 82 is formed of a mesh or a punched plate.

The food frying container 8 may further contain a plurality of collision wings 83 which protrude outward from an outer circumferential surface of the food accommodation container 82 and are configured to collide with the oil which is inputted during the input of the oil from the oil suction input unit 7 into the inside of the oil cask 2, thus allowing the foot accommodation container 8 to rotate and move.

It is preferred that the collision wings 83 are formed in such a way that the inclined directions of the collision wings 83 are alternately opposite to each other in the direction of the circumference of the food frying container 8 so that the collision wings 83 can collide with the oil erupting into the inside of the oil cask 2, thus allowing the oil cask 2 to move while rotating.

Meanwhile, at the circumference of the upper surface of the circumference fixing shoulder 211 forming the oil cask 2, there may be further provided a V-shaped guide groove 212 having a V-shaped cross section which is formed in a circular shape so that the semispherical surface 812 formed at a lower end portion of the vertical rod 811 can be inserted rotatable into the V-shaped guide groove 212.

Therefore, when oil is strongly erupted from the first eruption pipe 71 or the second eruption pipe 72 toward the collision wings 83, the erupted oil collides with the collision wings 83 formed protruding outward from the outer circumferential surface of the food accommodation container 82, whereupon the food frying container 8 rotates along the V-shaped guide groove 212, and at the same time, the both sides of the food frying container 8 minutely move upward and downward about the two vertical rods 811 since each collision wing 83 is inclined. Here, the two vertical rods 812 may be obtained by deforming two rollers 813 which stand vertical. In this case, since the two rollers 813 can move along the guide groove 212, operations can be performed more efficiently.

To this end, the food frying container 8 filled with foods can move, and the foods can minutely vibrate while the foods rotate during the frying of the foods, thus preventing foods from sticking to each other during the frying, and the foods can be uniformly cooked, and god quality fried foods can be obtained.

Meanwhile, an engaging shoulder 213 may be further formed at a circumference at the intermediate portion of the inner side of the cylindrical pipe 21 of the oil cask 2. A grill plate G may be mounted horizontal on the top of the engaging shoulder 213.

The circumference of the grill plate G may be mounted on the engaging shoulder 213, thus being engaged horizontal in the middle of the oil cask 2. Even though foods, for example, chicken, donuts, etc. is inputted in the oil cask 2, it is possible to prevent the foods from dropping down to the bottom of the oil cask 2.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A frying device, comprising:
a case 1 which is hollow and includes a circular hole 11 at its upper plate;
an oil cask 2 which is arranged passing through the circular hole 11 and includes a circumference fixing shoulder 211 formed at a circumference of its top and fixed at a circumference of the circular hole 11, a cylindrical pipe 21 the top and bottom of which are open, and an inverted cone shaped inclined, lower plate 22 formed at the open portion of the lower side of the cylindrical pipe 21, thus forming a discharge hole 23 at a lower portion of the front side;
a pair of ultrasonic wave vibration parts 3 which are provided at a front side and a rear side of an inner lower portion of the oil cask 2;
a pair of heater parts 4 which are dispose at both sides of an inner lower portion of the oil cask 2 and are configured to radiate heated air;
a sediment collection container 5 which is fixed at a lower portion of the discharge hole 23 while communicating with the oil cask 2;
a filtering circulation part 6 which is disposed between the sediment collection container 5 and the oil cask 2 so as to filter the oil discharging from the sediment collection container 5 and circulate back into the oil cask 2; and
a control part 9 which controls the ultrasonic wave vibration part 3, the heater parts 4 and the filtering circulation part 5, wherein an operation part 91 is connected to the control part 91.

2. The device of claim 1, wherein the filtering circulation part 6 comprises:
a first pipe 61 which extends from a lower portion of the sediment collection container and includes a control opening and closing valve 611 at its intermediate portion, which is connected to the control part 9;
a filter part 62 which is connected to an end portion of the first pipe 61 and allows to filter sediments; and
a second pipe 63 which extends from the filter part 62 and is connected to the top of the cylindrical part of the oil cask 2 and includes a pump 631 at its intermediate portion, which is connected to the control part 9, and feeds the oil filtered by the filter part 62 back into the oil cask 2.

3. The device of claim 2, wherein the filtering circulation part 6 comprises a fine filtering filter part 4 at the second pipe 63 which connects the pump 631 and the oil cask 2.

4. The device of claim 1, wherein each of the heater parts 4 comprises:
a body 41 which includes a heat discharge hole 411 at its outer side so as to discharge heat in the direction opposite to the direction where the two heater parts 4 face each other; and
a heater 42 which is disposed in the inside of the body 41 and allows to discharge heat based on the supply of electricity.

5. The device of claim 1, further comprising an oil suction input part 7 which is provided at a circumference of the cylindrical pipe 21 so as to continuously circulate the oil filled in the oil cask 2 with a vortex in a clockwise direction and a counterclockwise direction, and the control part 9 controls the oil suction input part 7.

6. The device of claim 5, wherein the oil suction input part 7 comprises:
a first eruption pipe 71 which is disposed horizontal passing through a circumference of the cylindrical pipe 21 and allows to erupt the oil in a clockwise direction on an inner circumferential surface of the cylindrical pipe 21;
a second eruption pipe 72 which is disposed horizontal passing through a circumference of the cylindrical pipe 21 and allows to erupt the oil in a counterclockwise direction on an inner circumferential surface of the cylindrical pipe 21; and
a normal and reverse direction pump 73 which is installed on an outer circumferential surface of the cylindrical pipe 21 and is connected to the control part 9, wherein the first eruption pipe 71 and the second eruption pipe 72 are connected through a connection pipe, thus sucking, circulating and inputting the oil filled in the inside of the oil cask 2.

7. The device of claim 6, further comprising:
a food frying container 8 which is installed over a circumference of the top of the oil cask 2 and is submerged in the inside of the oil cask 2 and is filled with foods and is configured to rotate and move while the oil is being inputted from the oil suction input part 7 into the inside of the oil cask 2.

8. The device of claim 7, wherein the food frying container 8 comprises:
a circumference engaging ring 81 which is disposed protruding outward from a circumference of its top, wherein a lower end portion thereof is formed in a shape of a semispherical surface 812 at front and rear sides of a lower portion thereof, and which includes two vertical rods 811 or rollers 813 contacting close with an upper surface of the circumference fixing shoulder 211;
an inverted cone shaped or cylindrical food accommodation container 82 which is formed protruding downward from the inside of the circumference engaging ring 81, wherein the top of which is open, and the bottom is closed, and the food accommodation container 82 is formed of a mesh or a punched plate; and
a plurality of collision wings 83 which are formed protruding outward from an outer circumferential surface of the food accommodation container 82 and are configured to collide with the oil during the input of oil from the oil suction input part 7 to the inside of the oil cask 2, thus rotating and moving the food accommodation container.

9. The device of claim 8, wherein the collision wings 83 are formed in such a way that the inclined directions are alternately opposite to each other in a circumference direction.

10. The device of claim 8, wherein the circumference fixing shoulder 11 comprises a V-shaped guide groove 212 which is formed in an arc shape on a circumference of its top, wherein a semispherical surface 812 formed at a lower end portion of each of the vertical roads 811 is inserted into the V-shaped guide groove 212.

11. The device of claim 1, wherein the oil cask 2 comprises an engaging shoulder 213 formed at a circumference of an intermediate portion in the inside of the cylindrical pipe 21, and the frying device comprises a grill plate G the circumference of which is mounted on the top of the engaging shoulder 213, so the grill plate G is engaged horizontal at an intermediate portion of the oil cask 2.
